(19) United States
(12) Patent Application Publication
(10) Pub. No.: US 2026/0138417 A1
(43) Pub. Date: May 21, 2026

(54) PILOT CONTROL METHOD FOR MODEL-BASED SETTING OF A WARM PATH TEMPERATURE IN AN AIR-CONDITIONING UNIT OF A MOTOR VEHICLE, AIR-CONDITIONING UNIT WITH CONTROL UNIT FOR CARRYING OUT THE PILOT CONTROL METHOD AND MOTOR VEHICLE WITH SUCH AN AIR-CONDITIONING UNIT

(71) Applicant: AUDI AG, Ingolstadt (DE)

(72) Inventors: Michael JONUSCHEIT, Gundelsheim (DE); Ralph KIRCHHOFF, Gaimersheim (DE)

(73) Assignee: AUDI AG, Ingolstadt (DE)

(21) Appl. No.: 19/375,593

(22) Filed: Oct. 31, 2025

(30) Foreign Application Priority Data
Nov. 21, 2024 (DE) 102024134280.3

(51) Int. Cl. B60H 1/00

(52) U.S. Cl. CPC B60H 1/0073; B60H 1/00064; B60H 1/00842; B60H 2001/00128

(57) ABSTRACT

A pilot control method for setting a warm path temperature in an air-conditioning unit of a motor vehicle. The steps include model-based setting a first warm path temperature setpoint value as a function of at least one air-conditioning parameter detected outside the warm path; setting an electrical power consumption of at least one electrical heating element as a function of the first warm path temperature setpoint value; model-based calculating a warm path temperature model value; comparing the warm path temperature model value with the warm path temperature setpoint value; determining an initial time when the warm path temperature model value reaches a lower or upper limit setpoint value; determining a time period from the start time to a predetermined end time, and upon reaching the end time, a renewed model-based setting of the first warm path temperature setpoint value is performed.

### FIELD

The invention relates to a pilot control method for setting a warm path temperature in an air-conditioning unit of a motor vehicle, an air-conditioning unit with a control unit for carrying out the pilot control method and to a motor vehicle with such an air-conditioning unit.

### BACKGROUND

The blow-out temperature control in an air-conditioning unit, which can also be referred to as an air-conditioning unit, is set in particular via a mixing ratio of two air mass flows. This is, on the one hand, the so-called fresh-air mass flow (cold) and an air mass flow in the warm path, which flows through one or more heating devices or sources (warm/hot). The mixing ratio is actively adjusted via so-called temperature flaps in order to set the desired blow-out temperature. For convenient air conditioning, it is also necessary to set the desired blow-out temperature at a certain mixing ratio, which is also known under the term stratification. In order to achieve this stratification, a setpoint temperature is specified for the warm path mass flow in order to achieve the blow-out temperature at a desired mixing ratio. This setpoint temperature is regulated in previously known air-conditioning units in a subordinate control circuit in the warm path on the basis of a plurality of temperature measuring points or temperature sensors downstream of the heating device or heat source.

It has been found that in practical application it is difficult to determine the warm path setpoint value, since the exact mass flows are not known. In order to compensate for inaccuracies, it is therefore known to repeatedly adjust the temperature of the warm path setpoint value in a control in order to achieve the desired blow-out temperature at a desired mixing ratio.

In particular, a subordinate control circuit at the heat source is required for such a procedure, which control circuit has several temperature sensors (up to eight units). Furthermore, such a procedure has a high tendency to oscillation of the coupled control circuits at an average control speed. This is particularly evident in the event of a change in the air mass flows and/or a change in the blow-out temperature setpoint values and/or when setting limits (power) are reached.

### SUMMARY

It is an object of the invention to provide a method which avoids the above disadvantages and in particular also leads to a design simplification of the air-conditioning unit.

This object is achieved by a pilot control method, an air conditioning unit and a motor vehicle.

A pilot control method for setting a warm path temperature in an air-conditioning unit of a motor vehicle is thus proposed, said pilot control method comprising the following steps:
model-based setting of a first warm path temperature setpoint value depending on at least one climate control parameter detected outside the warm path;
adjusting an electrical power consumption of at least one electrical heating element depending on the first warm path temperature setpoint value;
model-based calculating of a warm path temperature model value;
comparing the warm path temperature model value with the warm path temperature setpoint value;
determining a start time when the hot path temperature model value reaches a lower or upper limit setpoint value, wherein the lower and upper limit setpoint values forming a temperature band around the first hot path temperature setpoint value;
determining a time period from the start time to a predetermined end time if the warm path temperature model value is within the temperature band;
wherein a new model-based setting of the first warm path temperature setpoint value depending on at least one climate control parameter detected outside the warm path is performed when reaching the end time.

By means of such a, in particular model-based, pilot control method, it is possible to dispense with a subordinate control circuit having a plurality of temperature sensors arranged downstream of the heating device, so that an air-conditioning unit with a simplified and more cost-effective design is achieved. In other words, such a pilot control method replaces the control circuit for setting a warm path temperature. Furthermore, such a pilot control method reduces the tendency to oscillation.

A necessary accuracy of the actual warm path temperature is achieved by means of an iterative procedure, wherein the first warm path temperature setpoint value is repeatedly set or adapted if the warm path temperature model value remains within the temperature band for a certain time period, which generally only occurs when a certain operating point of the air-conditioning unit is reached in which the parameters on which the model-based pilot control is based do not change or change only slightly.

In the pilot control method, one or more of the following variables can be used as the air-conditioning parameters: an air temperature before entering the warm path, an ambient air temperature, an air mass flow conveyed into the warm air path, an interior air temperature, a position of a temperature flap of the air-conditioning unit. Furthermore, active power limitations can also be taken into account, such as, for example, a maximum or minimum conveyed air mass flow, a maximum or minimum power consumption in a heating device and the like.

In the pilot control method, the lower limit setpoint value and the upper limit setpoint value can form a temperature band of approximately 4 to 6° C. around the warm path temperature setpoint value, so that the starting time is determined when an amount of a difference between the warm path temperature model value and the warm path temperature setpoint value is 2 or 3° C.

The invention also relates to an air-conditioning unit for a motor vehicle, comprising at least one fan device; at least one evaporator connected to a refrigeration system; at least one heating device arranged downstream of the evaporator, in particular a heating register connected to the refrigeration system or at least one electrical heating element, wherein the heating device is arranged within a warm path of the air-conditioning unit; at least one cold path bypassing the warm path; at least one temperature flap arranged downstream of the warm path and the cold path; a mixing chamber formed downstream of the temperature flaps; and a plurality of outlets which can be brought into fluid communication with an interior of the motor vehicle; wherein the air-conditioning unit comprises a control unit which is adapted to carry out the above-described, in particular, model-based pilot control method.

The air-conditioning unit can be free of sensor devices for measuring the temperature of the warm air generated by the heating device downstream of the heating device and upstream of the temperature flap assigned to the warm path.

Furthermore, the air-conditioning unit can have at least one respective temperature sensor upstream of the heating device and downstream of the temperature flaps, in particular in the region of a respective outlet.

In other words, no temperature sensors are arranged in the warm path downstream or on the output side of the heating device, because these are not necessary if the control unit is able to determine the warm path temperature model value based on the model and to compare this with the warm path temperature setpoint value.

The invention also relates to a motor vehicle comprising a refrigeration system and an air-conditioning unit described above.

### BRIEF DESCRIPTION OF THE FIGURES

Further advantages and details of the invention will become apparent from the following description of examples, which can also be embodiments, with reference to the figures. In the figures:

FIG. 1 shows a simplified and schematic representation of an air conditioning unit in a motor vehicle;

FIG. 2 shows a simplified and schematic flow chart of a pilot control procedure;

FIG. 3 shows two simplified and schematic time/temperature diagrams for illustrating the pilot control method.

### DETAILED DESCRIPTION

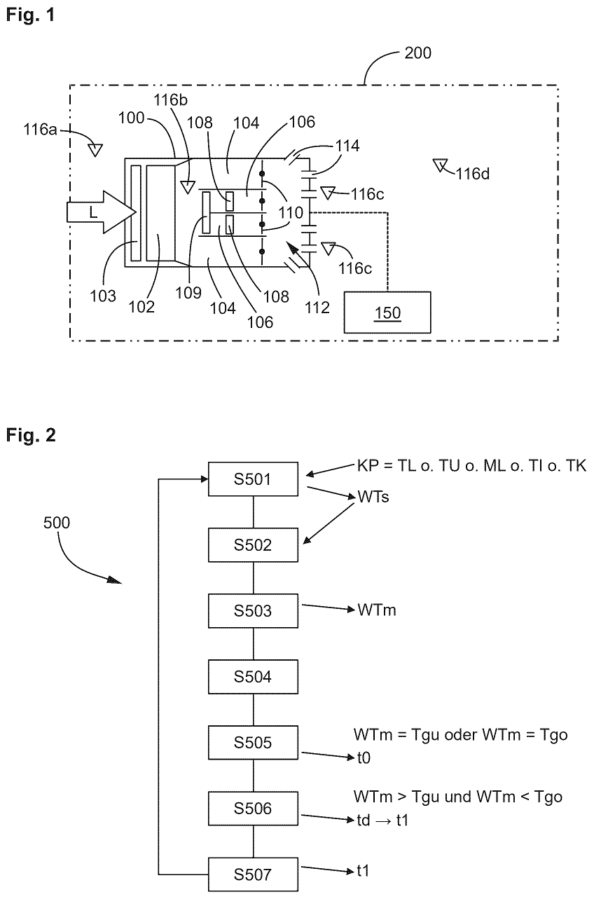

In FIG. 1, a motor vehicle 200 with an air-conditioning unit 100, which is also only schematically illustrated, is shown in greatly simplified and schematic form.

The air-conditioning unit 100 comprises at least one heat exchanger 102, in particular an evaporator for cooling and/or dehumidifying supplied air L. The air L or an air mass flow is conveyed in particular by a fan or a blower 103. Air ducts 104 for cooled air, which can also be referred to as a cold path, and air ducts 106 for air to be heated, which can also be referred to as a warm path, are shown in simplified form downstream of the evaporator 102.

The air-conditioning unit 100 has electrical heating elements 108 in the air ducts 106 or in the warm path, which are set up to heat the supplied air L as required. Alternatively or additionally, a heat exchanger 109, in particular a heating register, connected to a refrigeration system of the motor vehicle 200 can be arranged in the warm path, in particular upstream of the electrical heating elements 108. The heat exchanger 109 and/or the heating elements 108 can be referred to more generally as the heating device of the air-conditioning unit 100.

The air ducts 104, 106 can be (partially) released or (partially) closed by means of adjusting elements 110, such as flaps or the like. As a result, an air volume flowing through a respective air duct 104, 106 can be set. The adjusting elements 110 can also be referred to as temperature flaps.

Downstream of the temperature flaps 110, a mixing chamber 112 is arranged in which air introduced from the warm path 106 or the cold path 104 is at least partially mixed or layered.

The air-conditioning unit 100 also has a plurality of outlets 114 which can be brought into fluid communication or are in fluid communication with an interior of the motor vehicle 200.

The air-conditioning unit 100 further comprises a control unit 150 which is adapted to actuate individual components of the air-conditioning unit 100, such as, for example, a refrigeration system connected to the evaporator 102 and the heating register 109 and/or the electrical heating elements 108. The control unit 150 can also be part of a higher-level vehicle control unit.

The air-conditioning unit 100 can also have multiple temperature sensors. For example, a temperature sensor 116a may be provided for detecting an air temperature before entering the warm path 106. For example, a temperature sensor 116b may be provided for detecting a surrounding air temperature. Furthermore, respective temperature sensors 116c can be assigned to the outlets 114 in order to detect a respective outflow air temperature. An interior air temperature sensor 116d can be provided in an interior of the motor vehicle 200, for example.

It is pointed out that in FIG. 1, for reasons of better visibility, reference numeral 114 is not shown for all outlets and that a temperature sensor 116c is not shown for each outlet.

The temperature sensors 116a-d shown by way of example in the air-conditioning unit 100 are all arranged outside the warm path 106. In other words, the warm path 106 is, in particular, free of temperature sensors downstream of the heating register 109 and/or downstream of the electrical heating elements 108 and upstream of the temperature flaps 110, which sensors detect an air temperature in the warm air path 106.

FIG. 2 shows a simplified and schematic sequence of a pilot control method 500 for an air-conditioning unit 100. Such a pilot control method can be implemented or realized in particular by means of the control unit 150.

In the pilot control method 500, according to step S501, a model-based setting of a first warm path temperature setpoint value WTs takes place depending on at least one climate control parameter KP detected outside the warm path 106.

According to step S502, setting of an electrical power consumption of at least one electrical heating element 108 takes place depending on the first warm path temperature setpoint value WTs.

In step S503, model-based calculating of a warm path temperature model value WTm takes place.

In step S504, comparing of the warm path temperature model value WTm with the warm path temperature setpoint value WTs takes place.

In step S505, a start time t0 is determined when the warm path temperature model value WTm reaches a lower or upper limit setpoint value Tgu, Tgo, wherein the lower and upper limit setpoint values Tgu, Tgu form a temperature band around the first warm path temperature setpoint value WTs.

According to step S506, determining a time period td from the start time to to a predetermined end time t1 takes place, provided that the warm path temperature model value WTm is within the temperature band.

According to a step S507, the end time t1 is reached and the method returns to step S501, in which a new model-based setting of the first warm path temperature setpoint value WTs takes place depending on at least one climate control parameter detected outside the warm path 106.

The at least one air-conditioning parameter KP used as an input variable in step S501 may be one or more of the following variables, for example: an air temperature TL before entering the warm path 106, an ambient air temperature TU, an air mass flow mL conveyed into the warm air path, an interior air temperature TI, a position TK of a temperature flap 110 of the air conditioning unit 100.

In the pilot control method 500, the lower limit setpoint value Tgu and the upper limit setpoint value Tgo can form a temperature band of approximately 4 to 6° C. around the warm path temperature setpoint value WTs, so that the start time t0 is determined when an amount of a difference between the warm path temperature model value WTm and the warm path temperature setpoint value WTs is 2 or 3° C. In other words, t0 is defined when

$$\vert WTm - WTs \vert = 2 or 3 or \vert WTs - WTm \vert = 2 or 3$$

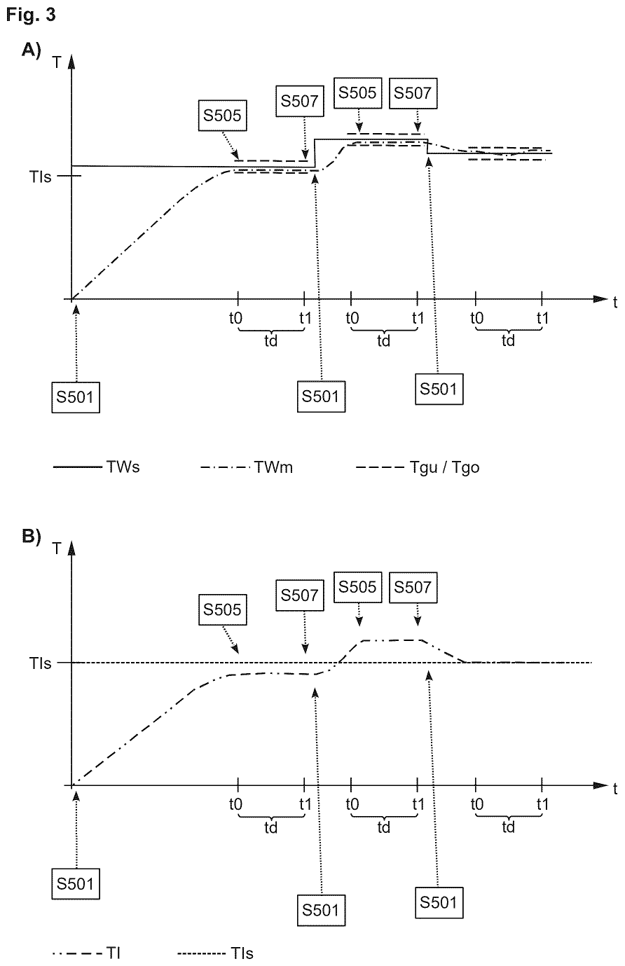

The above-described pilot control method 500 is explained below with reference to two temperature/time diagrams of FIG. 3.

In the diagram of FIG. 3A, the warm path temperature setpoint value TWs is shown as a solid black line. The model-based determined warm path temperature model value WTm is shown in dash-dotted lines. An interior temperature setpoint value TIs to be achieved, for example, in the vehicle interior, which can also be understood or referred to as the air-conditioning temperature setpoint value, is entered on the vertical axis. The lower and upper limit setpoint values Tgu and Tgo are respectively shown in longer dashed lines above and below the curve for the warm path temperature setpoint value TWs.

In the diagram of FIG. 3B, the interior temperature setpoint value Tis is shown as a narrow dashed line. The curve of a measured interior temperature value TI is shown in dash-dotted lines (three lines, two points).

Furthermore, the diagram of FIG. 3 partially shows the steps according to the method 500 described above, in particular the steps S501, S505 and S507.

Starting from a starting point which lies in the origin of the diagrams of FIG. 3, step S501 is carried out in the pilot control method. For example, an interior temperature value Tis to be achieved is specified. Settings are made on the air-conditioning unit 100 by means of the control unit 150, such as, for example, a specific power consumption in the electrical heating elements 108, a specific air flow quantity by means of the blower 103 and the like.

Based on one or more such air-conditioning parameters KP, a warm path temperature setpoint value TWs is determined or defined (solid line in FIG. 3A) and a model-based development of the warm path temperature model value TWm is continuously calculated (dash-dotted line in FIG. 3A).

If the model-based calculated warm path temperature model value TWm reaches the lower limit setpoint value Tgu (step S505), a start time to is determined. If the calculated warm-path temperature model value TWm remains within the temperature band formed by the limit setpoint values Tgu and Tgo, it is assumed that a stable operating state is reached. It is monitored whether this stable operating state is present during a certain time period td and then an end time t1 is reached.

If this is the case, for example at the end time t1; it can be compared whether the interior temperature value TI has already reached the interior temperature setpoint value TIs, which is apparent in FIG. 3B. This is apparently not yet the case after the first stable operating phase in FIG. 3A or FIG. 3B. It must be taken into account that the interior temperature TI represents a mixing temperature with heat losses

The advantage of model temperature monitoring, i.e. of TWm in relation to TWs, is in particular that malfunctions or restrictions can be detected in the air-conditioning unit 100, such as whether sufficient power is available at all by the electrical heating elements 108 in order to heat the air mass flow L to the setpoint level.

With reference to FIG. 3B, this means that at the first time to it is first determined that up to this point it has not yet been possible to provide sufficient power or energy in order to be able to reach the interior temperature setpoint value TIs.

During the stable operating state (t0 to t1), it can be checked, for example, whether an increase in the power consumption at the heating elements 108 is possible at all on the system side, in particular whether sufficient electrical energy can be provided that is not otherwise required in the motor vehicle.

Step S501 is carried out again and the warm path temperature setpoint value WTs is set to a higher level based on newly detected air-conditioning parameters. Corresponding to the new settings, the warm path temperature model value TWm is calculated continuously and on a model-based basis until this reaches the lower limit setpoint value Tgu again (second temperature band in FIG. 3A). The test for a stable operating state is repeated by determining the start time to, the time period td and the end time t1.

The interior temperature value TI then measured is higher than the interior temperature setpoint value TIs (FIG. 3B) at this point in time, so that an adaptation takes place again by carrying out method 500 starting with step S501.

FIG. 3A therefore shows that the pilot control method 500 is repeated or iteratively carried out with the model-based calculated warm path temperature model value TWm when a stable operating state is reached.

Based on this procedure, it is possible to dispense with temperature sensors which are usually arranged downstream of the heating elements 108 and/or downstream of the heating register 109 and upstream of the temperature flap 110.

1. A pilot control method for setting a warm path temperature in an air-conditioning unit of a motor vehicle, wherein said pilot control method comprises the following steps:
model-based setting a first warm path temperature setpoint value depending on at least one climate control parameter detected outside the warm path;
setting an electrical power consumption of at least one electrical heating element depending on the first warm path temperature setpoint value;
model-based calculating a warm path temperature model value;
comparing the warm path temperature model value with the warm path temperature setpoint value;
determining a start time when the warm path temperature model value reaches a lower or upper limit setpoint value, wherein the lower and upper limit setpoint values form a temperature band around the first warm path temperature setpoint value;
determining a time period from the start time to a predetermined end time, provided that the warm path temperature model value is within the temperature band;
wherein, upon reaching the end time, a renewed model-based setting of the first warm path temperature setpoint is performed depending on at least one air conditioning parameter detected outside the warm path.

2. The pilot control method according to claim 1, wherein one or more of the following variables are used as air conditioning parameters: an air temperature before entering the warm path, an ambient air temperature, an air mass flow conveyed into the warm air path, an interior air temperature, a position of a temperature flap of the air conditioning unit.

3. The pilot control method according to claim 1, wherein the lower limit setpoint value and the upper limit setpoint value form a temperature band of approximately 4 to 6° C. around the warm path temperature setpoint value, so that the start time is determined when an amount of a difference between the warm path temperature model value and the warm path temperature setpoint value is 2 or 3° C.

4. An air conditioning unit for a motor vehicle, comprising:
at least one fan device;
at least one evaporator connected to a refrigeration system;
at least one heating device arranged downstream of the evaporator, in particular a heating register connected to the refrigeration system or at least one electrical heating element,
the heating device is arranged within a warm path of the air-conditioning unit;
at least one cold path bypassing the warm path;
at least one temperature flap arranged downstream of the warm path and the cold path;
a mixing chamber formed downstream of the temperature flaps;
multiple outlets which can be fluidically connected to an interior of the motor vehicle;
wherein the air conditioning unit has a control unit configured to carry out the pilot control method according to claim 1.

5. The air-conditioning unit according to claim 4, wherein it is free of sensor devices for measuring the temperature of the warm air generated by the heating device downstream of the heating device and upstream of the temperature flap assigned to the warm path.

6. The air-conditioning unit according to claim 4, wherein it has at least one respective temperature sensor upstream of the heating device and downstream of the temperature flaps, in particular in the region of a respective outlet.

7. A motor vehicle with a refrigeration system and with an air-conditioning unit according to claim 4.

8. The pilot control method according to claim 2, wherein the lower limit setpoint value and the upper limit setpoint value form a temperature band of approximately 4 to 6° C. around the warm path temperature setpoint value, so that the start time is determined when an amount of a difference between the warm path temperature model value and the warm path temperature setpoint value is 2 or 3° C.

9. The air-conditioning unit according to claim 5, wherein it has at least one respective temperature sensor upstream of the heating device and downstream of the temperature flaps, in particular in the region of a respective outlet.
